(19) United States
(12) Patent Application Publication
(10) Pub. No.: US 2008/0201162 A1
(43) Pub. Date: Aug. 21, 2008

(54) E-INTERVIEW SYSTEM AND METHOD

(76) Inventor: William Hart, Hoover, AL (US)

Correspondence Address: W. EDWARD RAMAGE, COMMERCE CENTER SUITE 1000, 211 COMMERCE ST, NASHVILLE, TN, 37201, US

(21) Appl. No.: 11/957,033

(22) Filed: Dec. 14, 2007

Related U.S. Application Data
(60) Provisional application No. 60/870,035, filed on Dec. 14, 2006.

(51) Int. Cl. G06Q 99/00; G06Q 10/00; G06F 17/00

(52) U.S. Cl. 705/1; 707/104.1; 707/E17.001

(57) ABSTRACT

A system and method to create, present, and search “E-Interview” information. E-Interview information may comprise one or more of the following: a resume, a cover letter, a personality profile and interests, a perfect or ideal job description exercise, a character and values profile, a values statement, career goals, pre-answered job questions, other profiles or information selected by the applicant, employment questionnaires related to job function and values philosophy, goal-setting and job search tools, and video presentations. It also may comprise a picture of the applicant, voice-only interviews (in MP3 or other format), and statistics information that indicates how many times the applicant's profile has been viewed by potential employers. The information may be presented in a single website, as opposed to multiple websites or sources. A website containing multiple E-Interviews may be accessible by potential employers. The site may include a variety of tools to assist the employer in creating job profiles, evaluating candidates, building a talent pool, and the like, and tools to assist a job-seeker to create and present the E-Interview information. Some or all of the E-Interview information may be downloaded onto a CD or DVD.

This application claims benefit of, and priority to, U.S. Provisional Patent Application No. 60/870,035, filed Dec. 14, 2006, entitled “E-INTERVIEW SYSTEM AND METHOD.” The complete specification, drawings, attachments and disclosure of U.S. Provisional Patent Application No. 60/870,035 are incorporated herein by specific reference.

### FIELD OF INVENTION

This invention relates to a system and method for the presentation of information by individuals seeking employment. More particularly, the invention relates to a method for job seekers to market themselves in a more holistic manner, presenting a combination of a video, personality profile, career goals, and other information in addition to a standard resume.

### BACKGROUND OF THE INVENTION

The labor market in the United States currently is facing many challenges. With changing demographics, especially an aging population and a growing labor shortage, employers are finding it more difficult to fill positions. The cost of identifying suitable employees is increasing. Organizations are spending more dollars to find employees with the “right fit.” Paying a recruiter can cost up to one-third of an employee's first year's salary. The cost of turnover is significant, as well.

Employers use a variety of search tools for finding candidates. Typically, finding new employees typically has been a one or two dimensional process drawn out over time, consisting of the steps of reviewing resumes and interviewing the candidates. The person's personality, which can be considered the largest determinant of job performance, is generally not fully discovered until after they are hired. The current two-dimensional employment process is a costly and ineffective way to determine if a candidate meets the job requirements and will be an effective employee for the particular position. It is ambiguous, drawn-out, expensive, and frequently frustrating for both employers and job candidates.

Job-listing sites on the Internet is one such tool. Because of the large volume, existing job-posting web sites are ineffective and inefficient. The search tools for finding candidates are poor, and too many or too few candidates respond to a job posting.

Some organizations use pre-employment testing as a tool to determine if a candidate is a “good fit.” However, the challenge is that the employer must first find the candidate to profile him or her for a fit.

Accordingly, what is needed is a tool that enables employers to identify and evaluate job seekers as a “good fit” before he or she is contacted for an interview, and view the candidate in a holistic manner, allowing employers to search for specific backgrounds, personality and values profiles.

### SUMMARY OF THE INVENTION

The present invention is a system and method for job seekers to market themselves in a more holistic manner by presenting an “E-Interview.” An E-Interview may comprise a video, personality profile, career goals, and other information in addition to a standard resume, thereby enabling potential employers to identify and evaluate job seekers as a “good fit” before he or she is contacted for an interview, and view the candidate in a holistic manner, allowing to search for specific backgrounds, personality and values profiles. The E-Interview information may be presented on-line at a website on the Internet or a network. The system creates a three-dimensional employment process, where a candidate's technical qualifications (e.g., resume), presentation (e.g., video interview) and personality (e.g., personality profile or survey) are all presented at once, in one location, at the front end of the employment process. This reduces the time, cost and risk of the current employment process, and in particular, the risk of a poor hire.

In one exemplary embodiment, an E-Interview comprises one or more of the following: a resume, a cover letter, a personality profile and interests, a perfect or ideal job description exercise, a character and values profile, a values statement (which may have examples of where applied), career goals, pre-answered job questions (which may be in text or some voice-only format, such as MP3 or .wav file format), other profiles or information selected by the applicant, employment questionnaires related to job function and values philosophy, goal-setting and job search tools (which may include accountability emails), and video presentations. It also may comprise a picture of the applicant, voice-only interviews (in MP3 or other format), and statistics boxes or information that indicates how many times the applicant's profile has been viewed by potential employers. In one particular embodiment, the E-Interview information comprises a resume, a character and values profile, and a applicant video presentation.

In another embodiment, the above-described E-Interview information may be presented in a single website, as opposed to multiple websites or sources. Each job seeker may have a particular website, webpage, or URL for himself or herself. Alternatively, a central jobs website may contain multiple E-Interviews for multiple job seekers. In yet another embodiment, some or all of the E-Interview information may be downloaded onto a CD or DVD.

A website containing multiple E-Interviews may be accessible by potential employers. The site may include a variety of tools to assist the employer in creating job profiles, evaluating candidates, building a talent pool, and the like, and tools to assist a job-seeker to create and present the E-Interview information.

### DESCRIPTION OF THE DRAWINGS

FIG. 1 shows a starting web page of a system in accordance with one embodiment of the present invention.

FIG. 2 shows a log-in web page of a system in accordance with one embodiment of the present invention.

FIG. 3 shows an account creation page of a system in accordance with one embodiment of the present invention.

FIG. 4 shows an example of a fee page of a system in accordance with one embodiment of the present invention.

FIG. 5 shows another example of a fee page of a system in accordance with one embodiment of the present invention.

FIG. 6 shows an information page of a system in accordance with one embodiment of the present invention.

FIG. 7 shows an employer option page of a system in accordance with one embodiment of the present invention.

FIG. 8 shows a job profile creation page of a system in accordance with one embodiment of the present invention.

FIG. 9 shows a candidate search page of a system in accordance with one embodiment of the present invention.

FIG. 10 shows a current employee profile page of a system in accordance with one embodiment of the present invention.

FIG. 11 shows a employer coaching tool page of a system in accordance with one embodiment of the present invention.

FIGS. 12 through 16 show an example of a job analysis process of a system in accordance with one embodiment of the present invention.

FIG. 17 shows a candidate match screen of a system in accordance with one embodiment of the present invention.

FIGS. 18 through 20 show examples of a candidate master or portfolio page of a system in accordance with one embodiment of the present invention.

FIG. 21 shows another example of a candidate master page of a system in accordance with one embodiment of the present invention.

FIGS. 22 through 24 show an example of a profile report for a job seeker, in accordance with one embodiment of the present invention.

FIG. 25 shows an example of a job seeker option page in accordance with one embodiment of the present invention.

FIG. 26 shows an exemplary embodiment of a candidate master or portfolio page for a law student seeking a summer clerk position.

### DETAILED DESCRIPTION OF THE INVENTION

The present invention is a system and method for job seekers to market themselves in a more holistic manner by presenting an “E-Interview,” which may comprise a video, personality profile, career goals, and other information in addition to a standard resume, thereby enabling potential employers to identify and evaluate job seekers as a “good fit” before he or she is contacted for an interview, and view the candidate in a holistic manner, allowing employers to search for specific backgrounds, personality and values profiles. The E-Interview information may be presented on-line at a website on the Internet or a network.

In one exemplary embodiment, an E-Interview comprises one or more of the following: a resume, a cover letter, a personality profile and interests, a perfect or ideal job description exercise, a character and values profile, a values statement (which may have examples of where applied), career goals, pre-answered job questions (which may be in text or some voice-only format, such as MP3 or .wav file format), other profiles or information selected by the applicant, employment questionnaires related to job function and values philosophy, goal-setting and job search tools (which may include accountability emails), and video presentations. It also may comprise a picture of the applicant, voice-only interviews (in MP3 or other format), and statistics boxes or information that indicate how many times the applicant's profile has been viewed by potential employers. In one particular embodiment, the E-Interview information comprises a resume, a character and values profile, and a applicant video presentation.

In another embodiment, the above-described E-Interview information may be presented in a single website, as opposed to multiple websites or sources. Each job seeker may have a particular website or webpage or URL for himself or herself. Even within the single website system, each job seeker may also have their own URL for their information. Alternatively, a central jobs website may contain multiple E-Interviews for multiple job seekers. In yet another embodiment, some or all of the E-Interview information may be downloaded onto a CD or DVD, which the job seeker may distribute to potential employers.

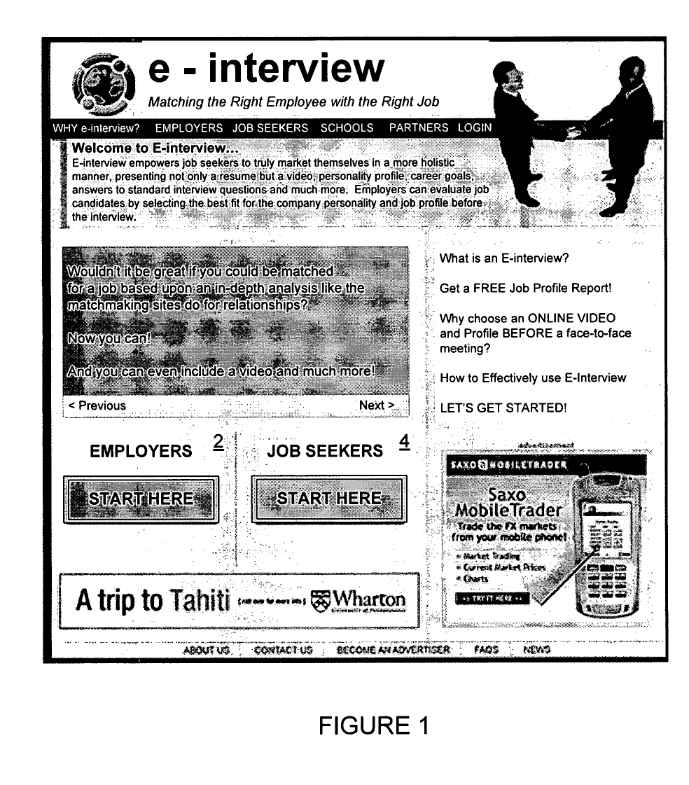

A website containing multiple E-Interviews may be accessible by potential employers. The site may include a variety of tools to assist the employer in creating job profiles, evaluating candidates, building a talent pool, and the like, and tools to assist a job-seeker to create the E-Interview information. FIG. 1 shows an example of a starting web page offering access to both employers 2 and job seekers 4. This embodiment can obtain a large number of job seekers (who can register individually or several at one time) in order to populate a database which will attract employers. One means of getting a large number of job seekers to register at one time is to target companies that are downsizing their workforce. Another means is through college career centers for those who have little to no job experience.

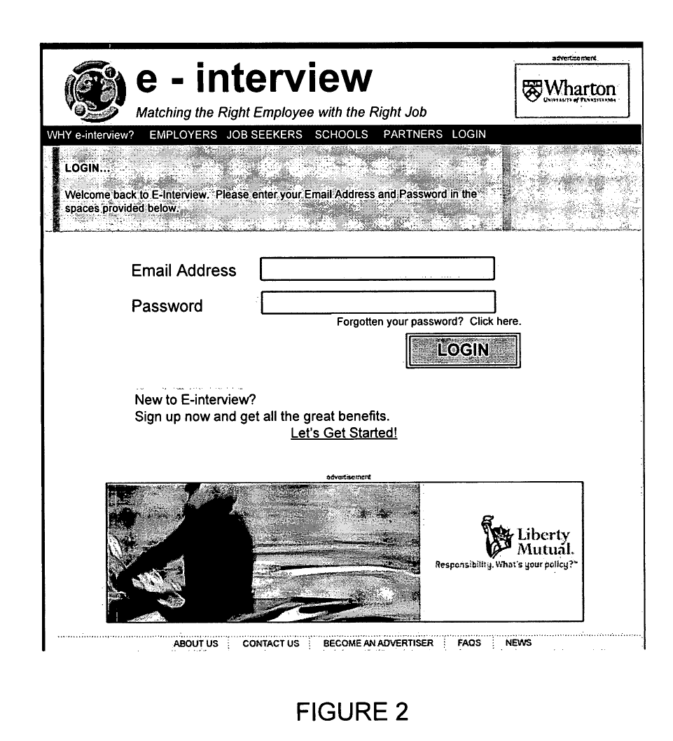

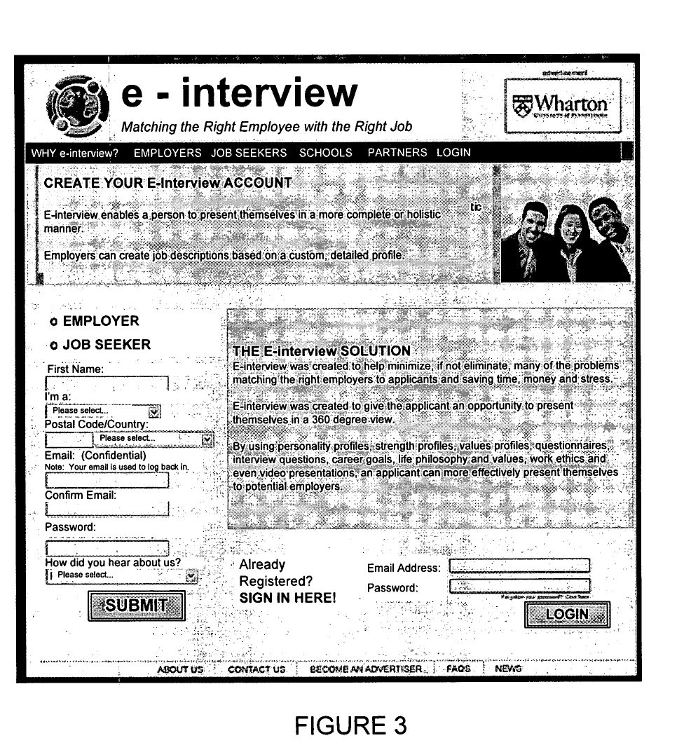

FIG. 2 shows log-in page for one embodiment of an E-Interview system. This page may be used for both employers and job-seekers. New users of either type may be prompted to create an account, as shown in FIG. 3. The user may select the type of account on this page, or alternatively, may be lead to a specific employer or job-seeker account creation page by selection of the appropriate user type on the initial page, as shown in FIG. 1.

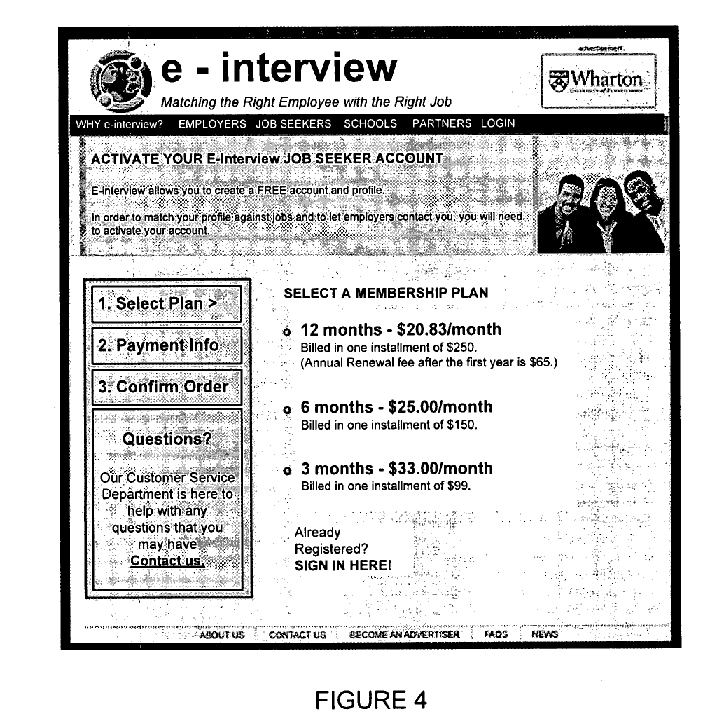

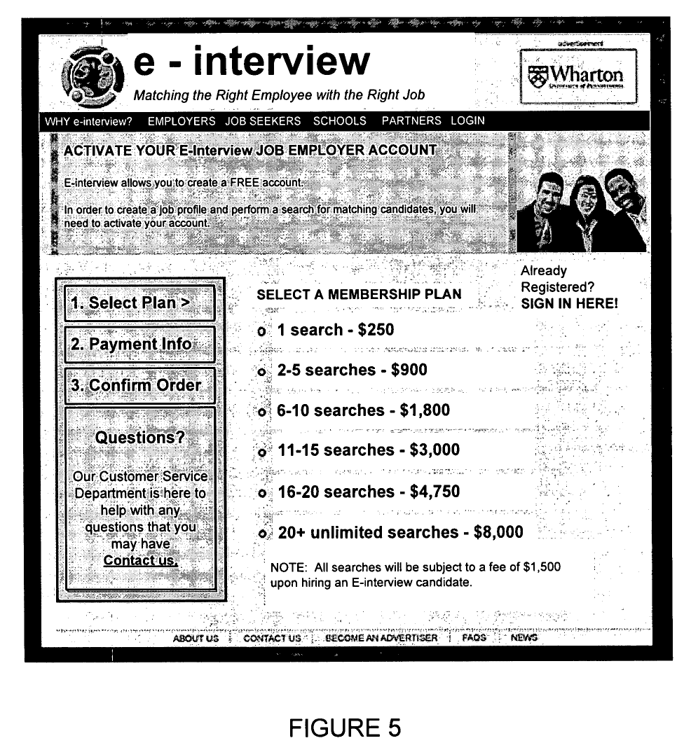

In one exemplary embodiment, the E-Interview system generates revenue from both job seekers and employers. FIGS. 4 and 5 show examples of subscription or payment plans for job-seekers and employers, respectively. Job seekers may pay a fee to build their E-Interview material (and subsequent fees for modifications), although the creation of the account and profile (and other materials) may be free, and a periodic maintenance or renewal fee (for an appropriate period of time, which could be a month, 6-months, or a year) to keep the information posted and/or updated. Employers would pay a fee to conduct a search (the fee could be a fixed fee per search, or based on upon various parameters, such as, but not limited to, job type, geographic area, number of hits, or the like). Alternatively, employers could pay a periodic fee or subscription fee, which could be fixed, or could vary depending on various parameters, such as, but not limited to, how many candidate searches were performed, job type, geographic area, number of hits, or the like. Successful hiring of a candidate found through the E-Interview site also could result in a separate fee, as indicated in FIG. 5.

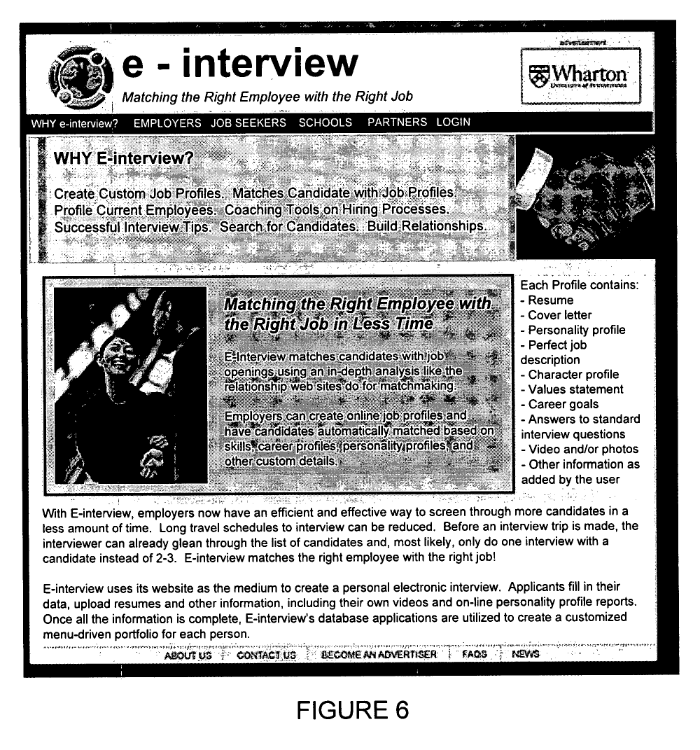

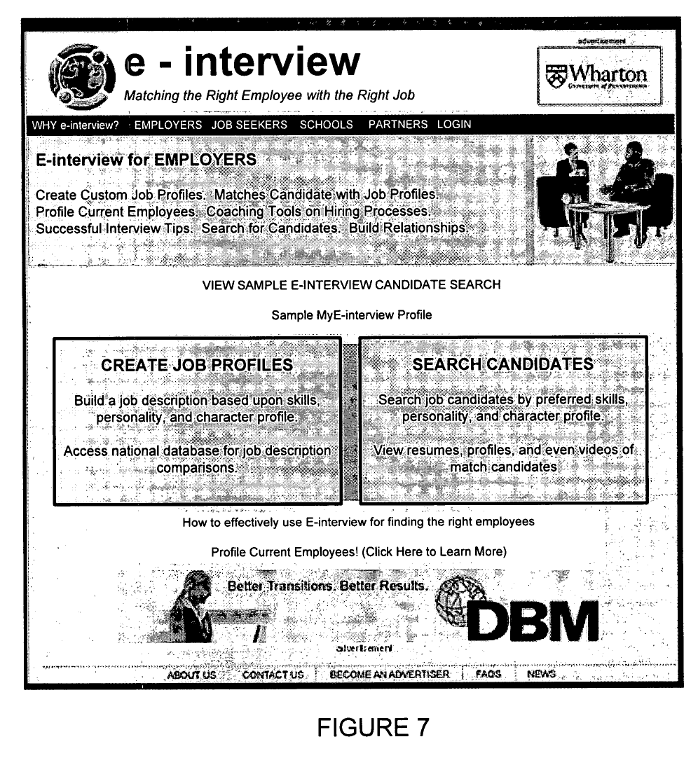

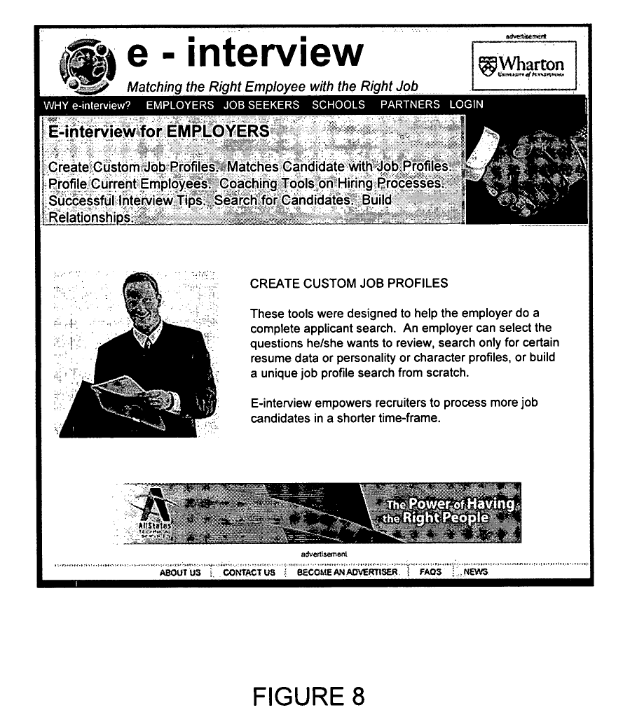

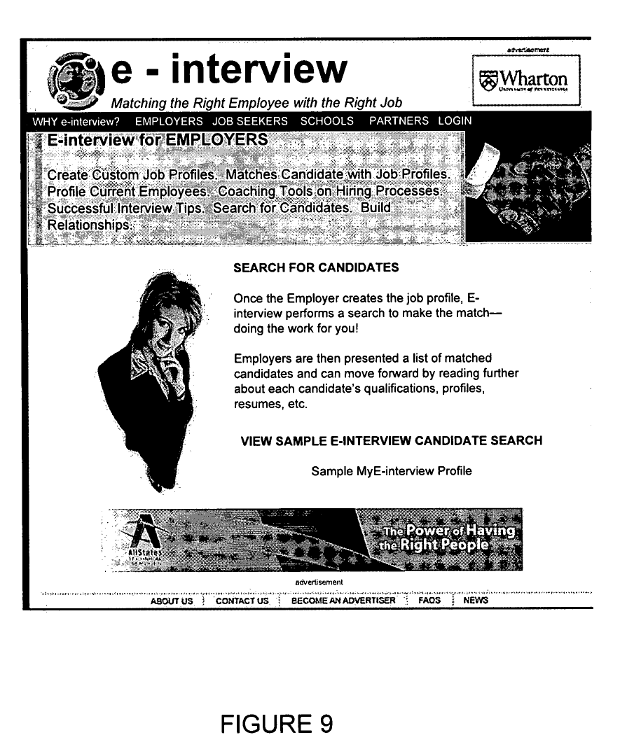

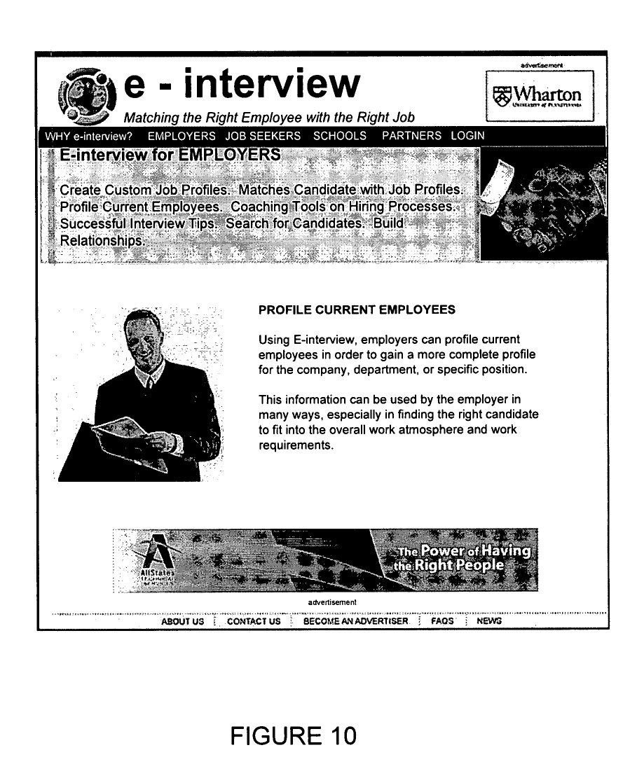

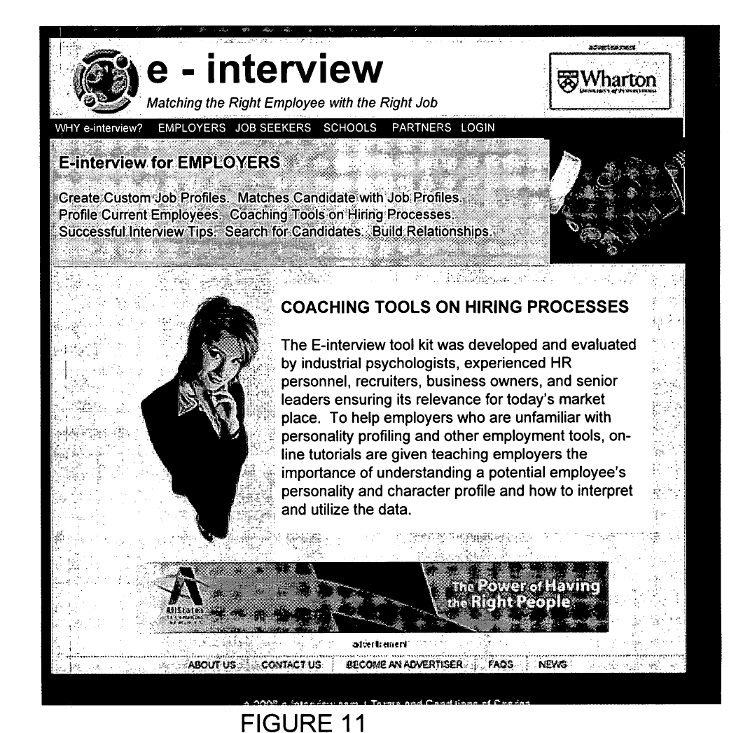

FIG. 6 is an example of a information page about the E-Interview system. FIG. 7 gives employers the option to create a job profile for listing 10, or conducting a search for candidates 12. Selecting the job profile option takes the user through the job profile creation process (see FIG. 8). Selecting the search for candidates option takes the user through the candidate search process (see FIG. 9). In an alternative embodiment, the employer also can choose to profile current employees in order to gain a more complete profile for the company, department, or a specification position, as seen in FIG. 10. The employer also may be provided with a series of on-line tutorials and coaching tools on understanding, interpreting, and using the personality and character profile data (see FIG. 11).

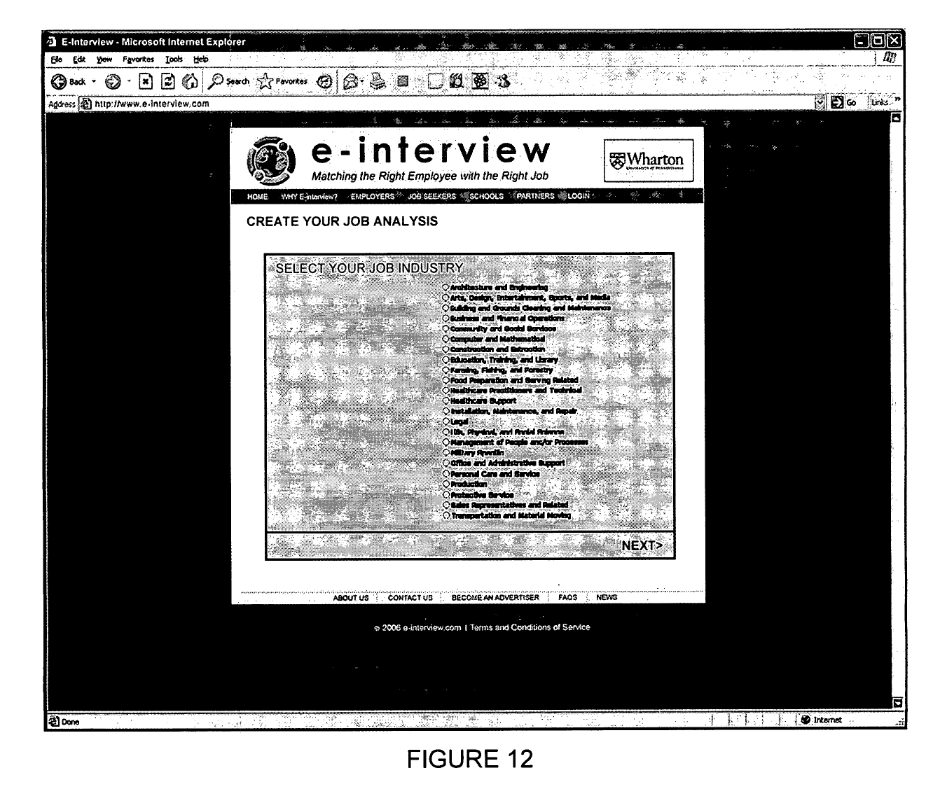

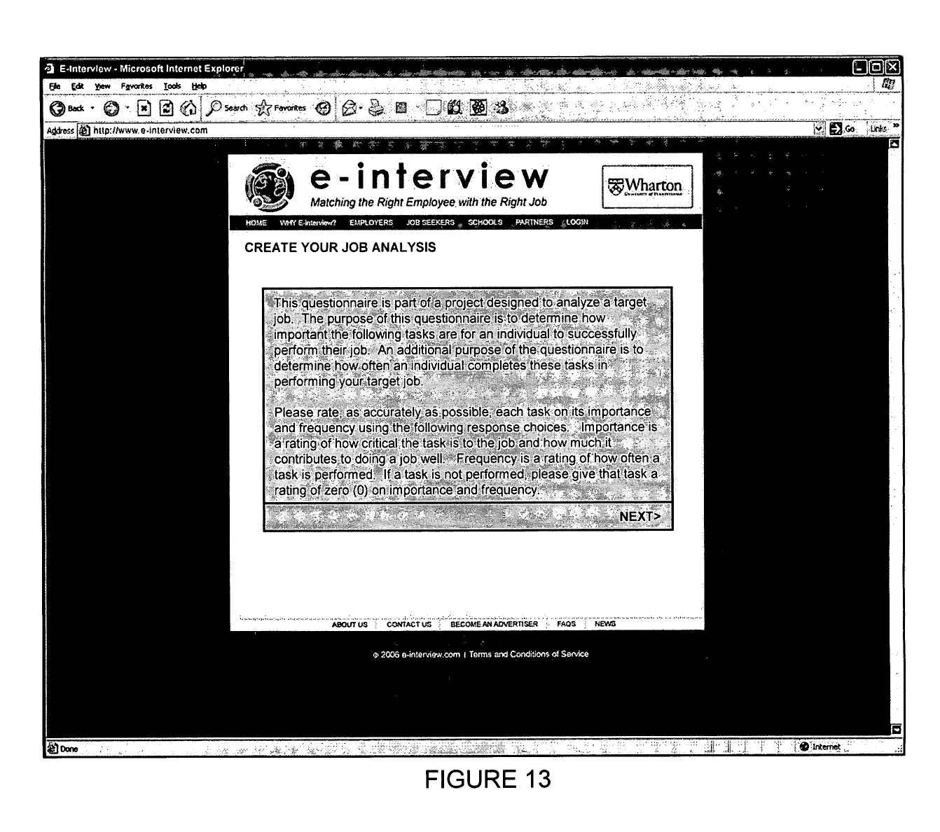

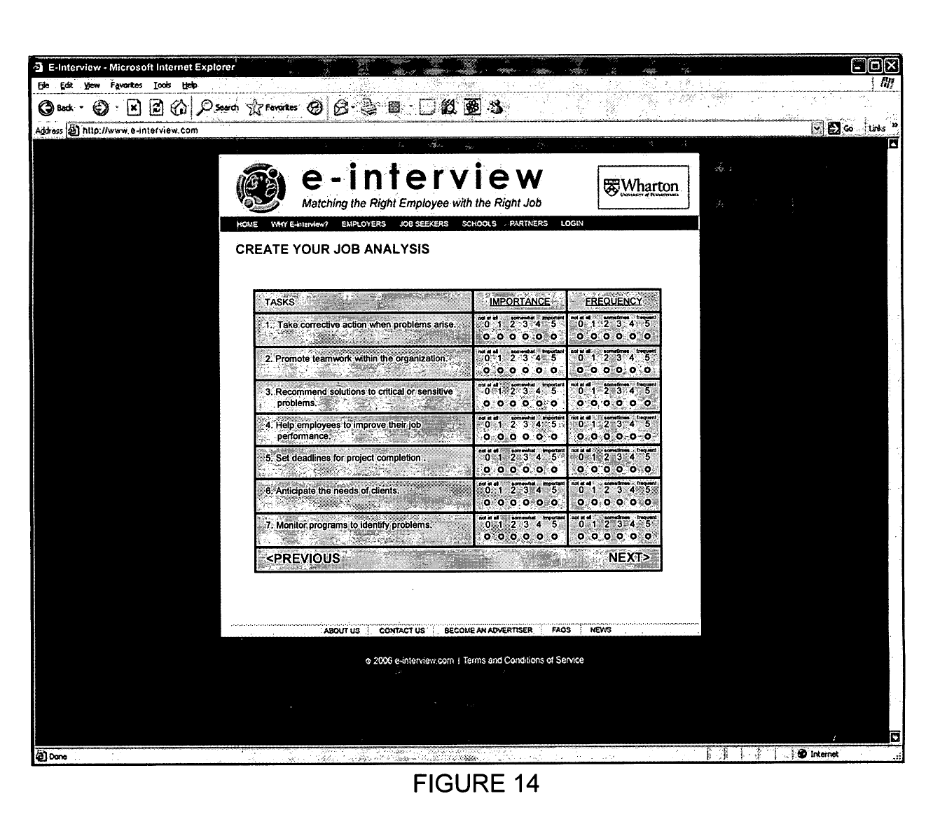

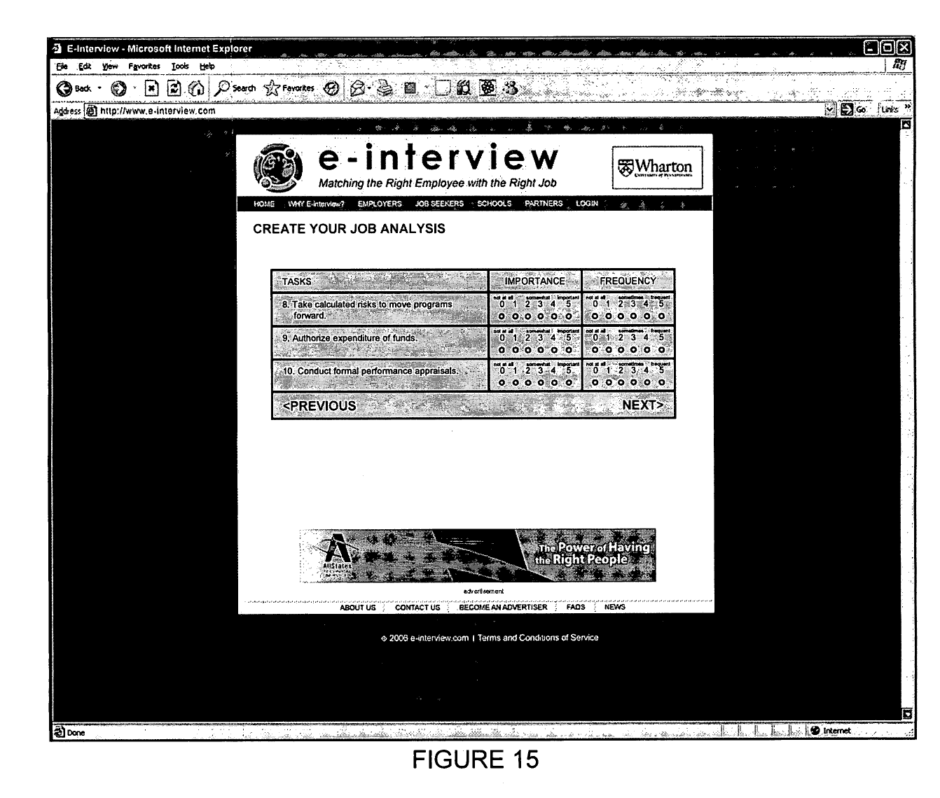

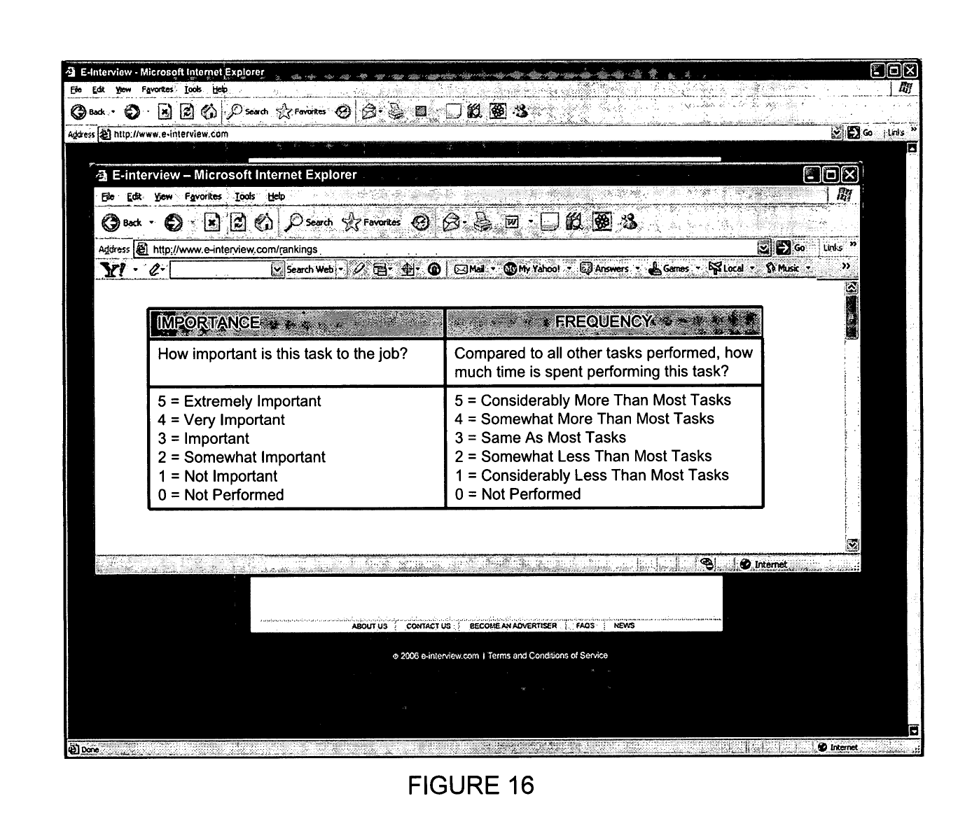

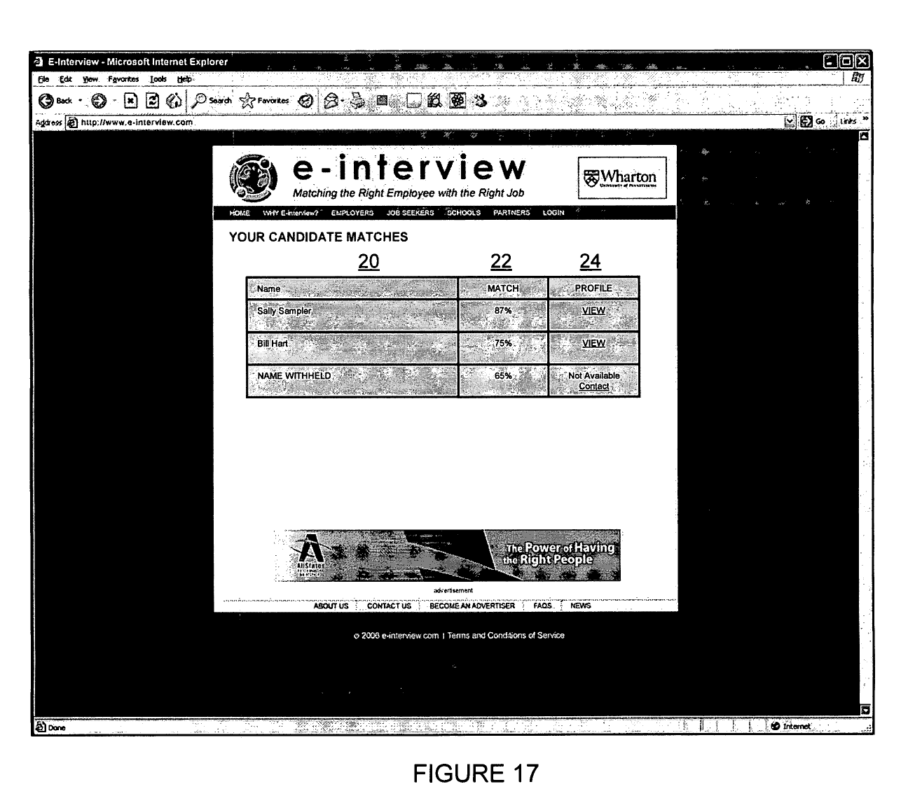

FIGS. 12 through 16 show an example of a job analysis process used by an employer. The process shown requests the user to rank certain tasks for importance and frequency. The data input may then be used to match and identify candidate job-seekers for the particular job that is the subject of the analysis. As shown in FIG. 17, a candidate match screen can show a list of the names of candidates (some names may be withheld for certain reasons, such as at the request of the candidate) 20, an indication of how well the candidate matches the job description (shown here as a percentage) 22, and the option 24 for the user to view the E-Interview materials for the candidate, or to initiate contact with them in order to gain access to the E-Interview materials.

Searches can be performed on other parameters, including the ability to search on all or any a few desired fields. Employer users may be able to record and share notes about applicants or candidates with others in the employer's organization. Employer users also may evaluate a rate an E-Interview, online or offline. Employers also may be notified if a new E-Interview profile is created by a job seeker that matches a persistent job profile previously created by the employer and that is currently active.

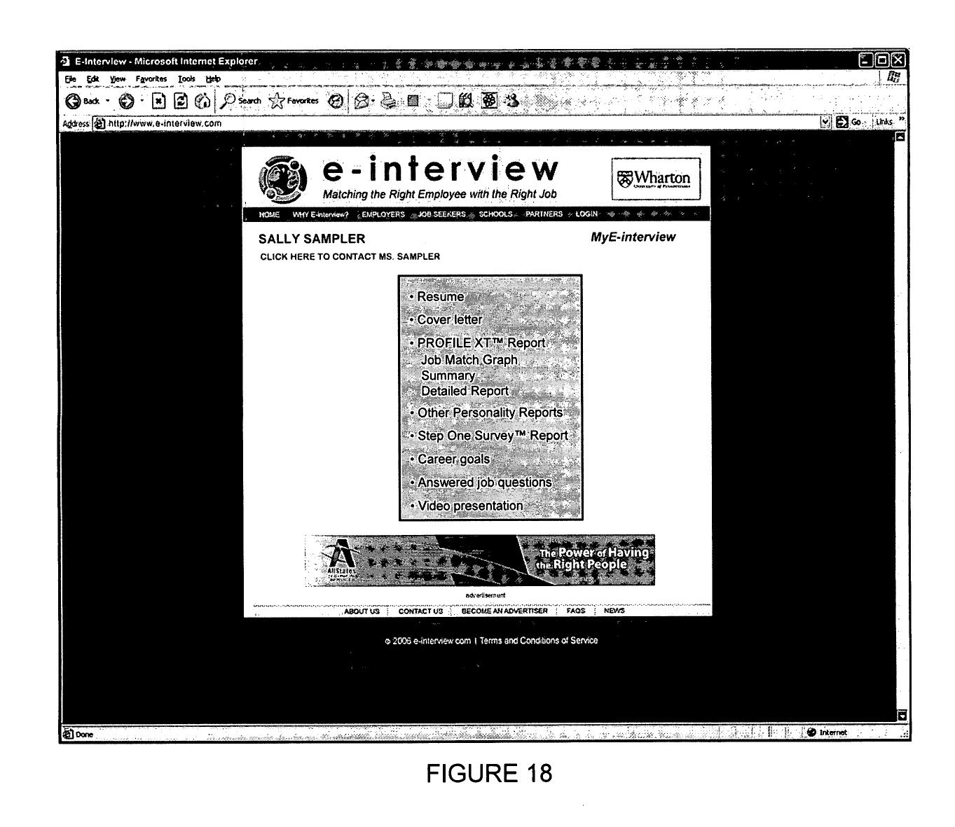

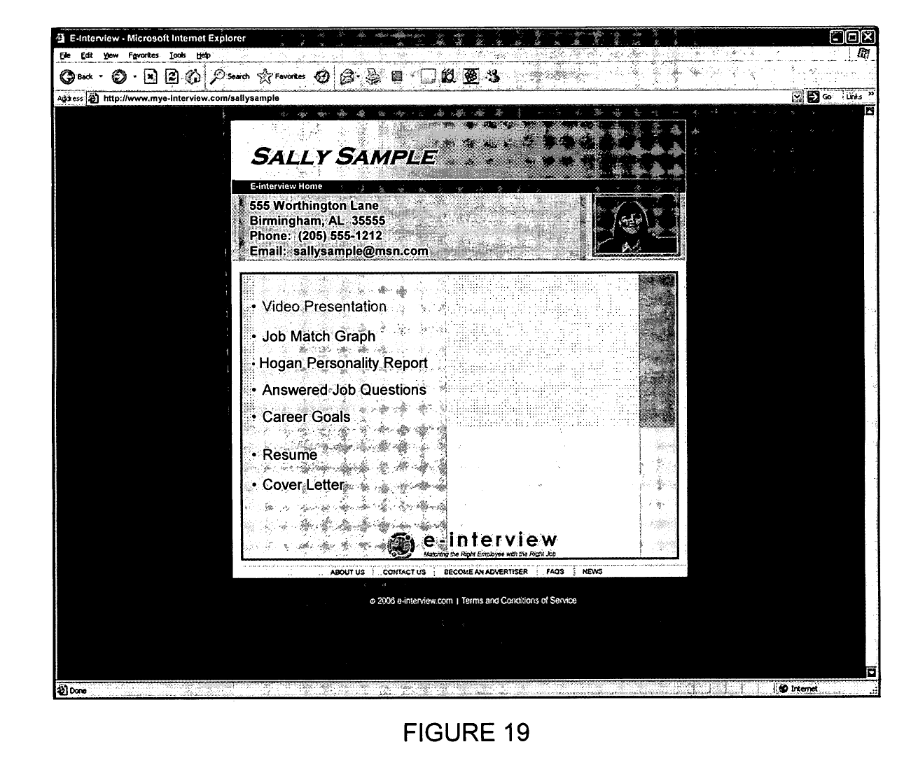

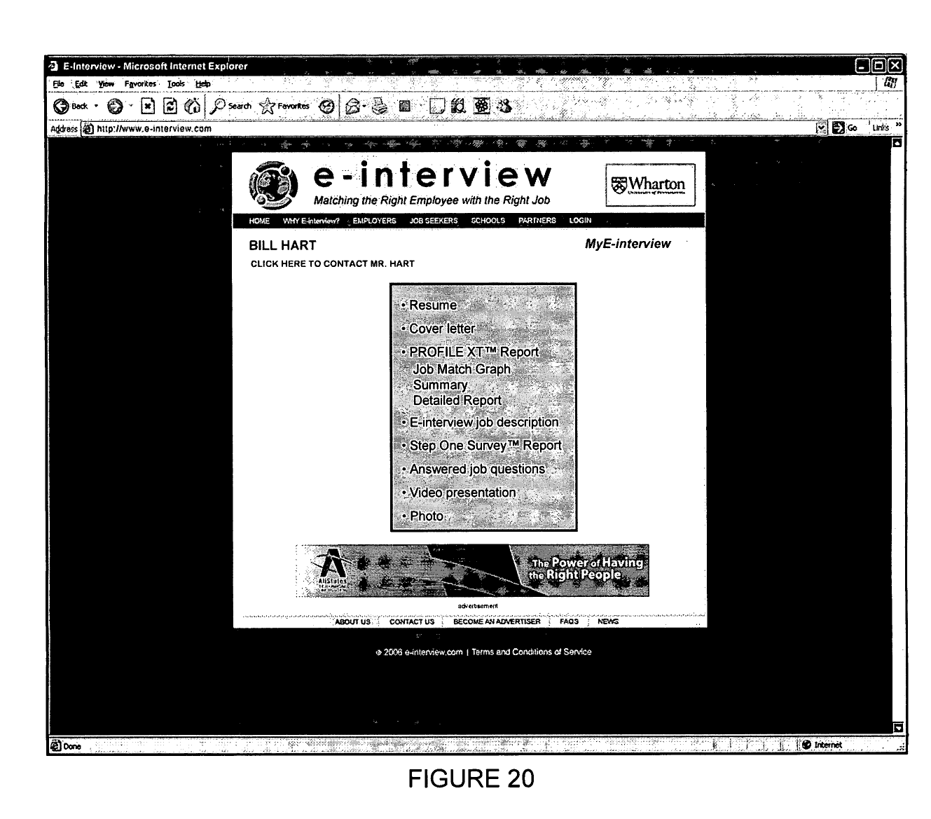

FIGS. 18 through 20 show alternative examples of an E-Interview master page or portfolio for a job seeker that the employer user may be directed to. The master page may provide a series of links to particular elements of the E-Interview materials, such as the resume, cover letter, Profile XT Report components, personality reports, Step One Survey Report, career goals, answered job questions, Hogan personality report or any personality profile report, photo and video presentations. As shown in FIG. 19, a picture, address, and contact information may also be provided on this page, or as shown in FIG. 18, accessed through this page. These master pages are created by the job seeker, with the seeker using pre-set templates or custom templates created and uploaded by the user.

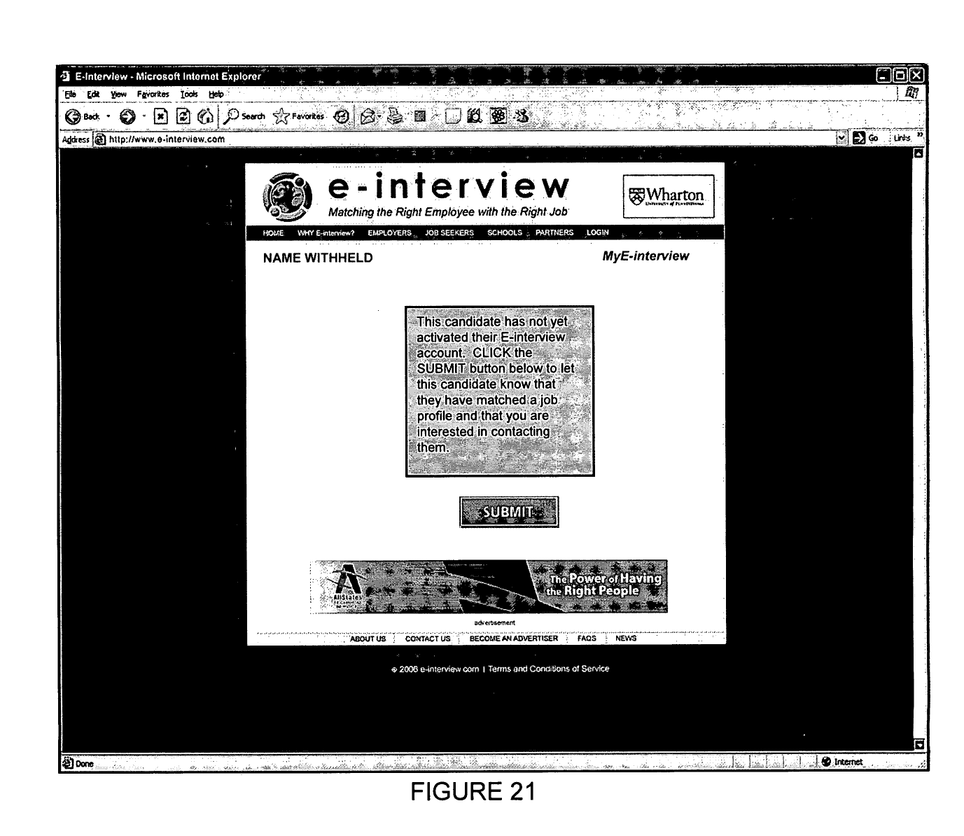

FIG. 21 shows an example of a master page for a job seeker that has not yet activated their E-Interview account, but their data is in the site database so they can be identified as a candidate. A similar page with an appropriate message may be used for individuals that have activated their E-Interview account, but want the information kept confidential and released only upon request and approval.

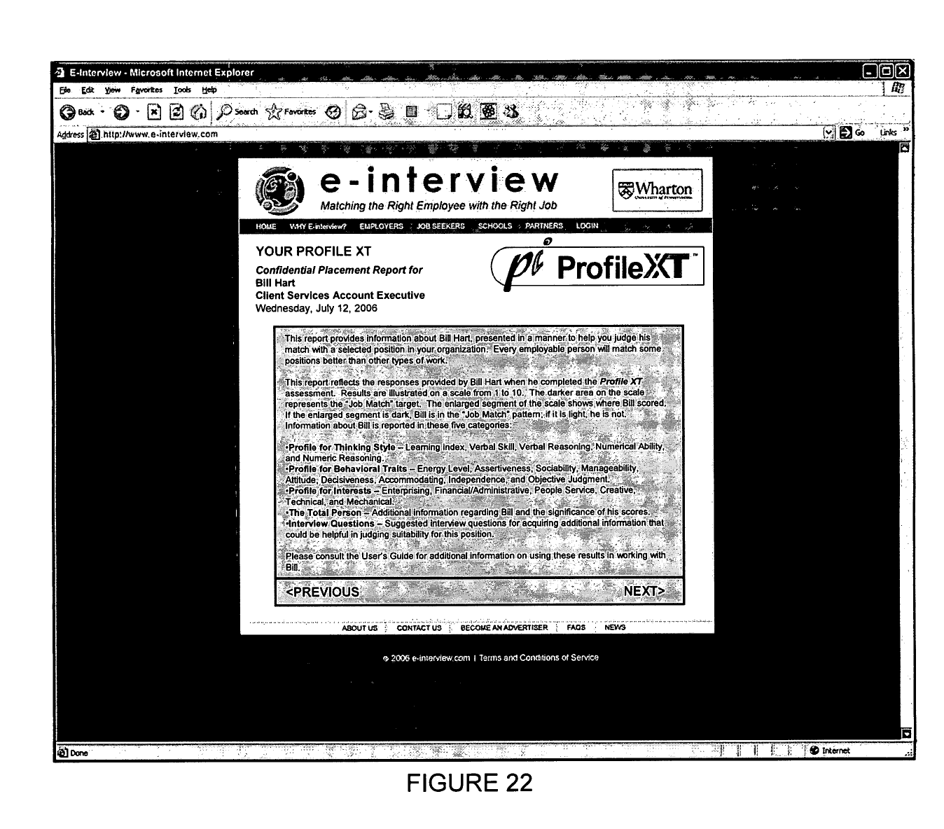

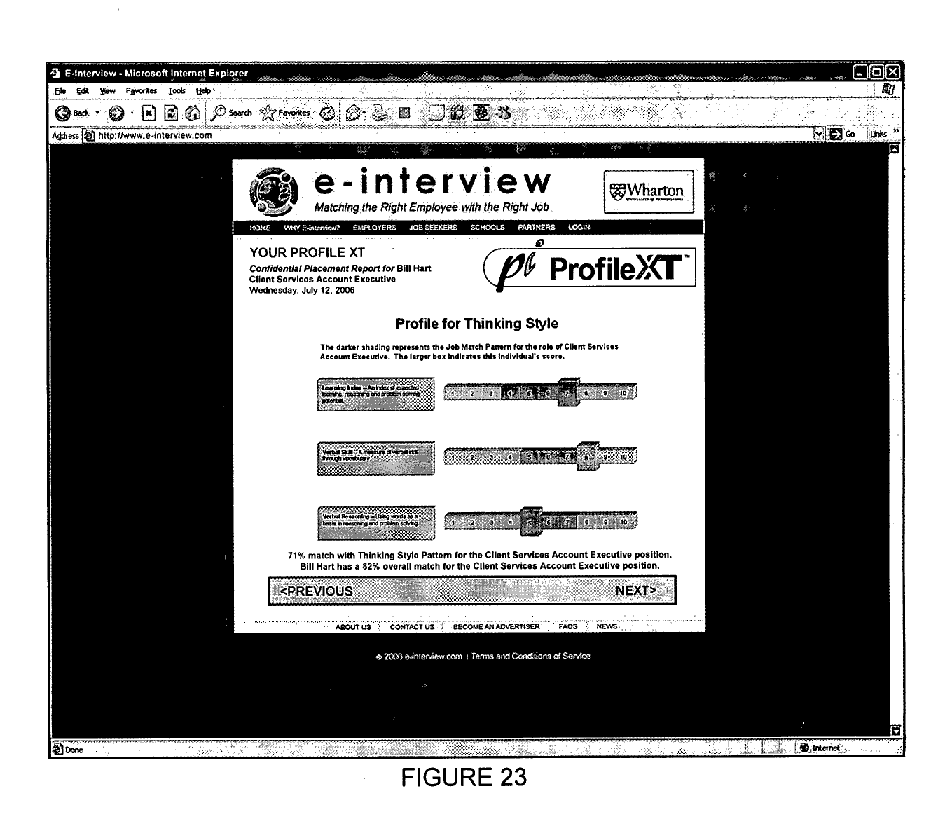

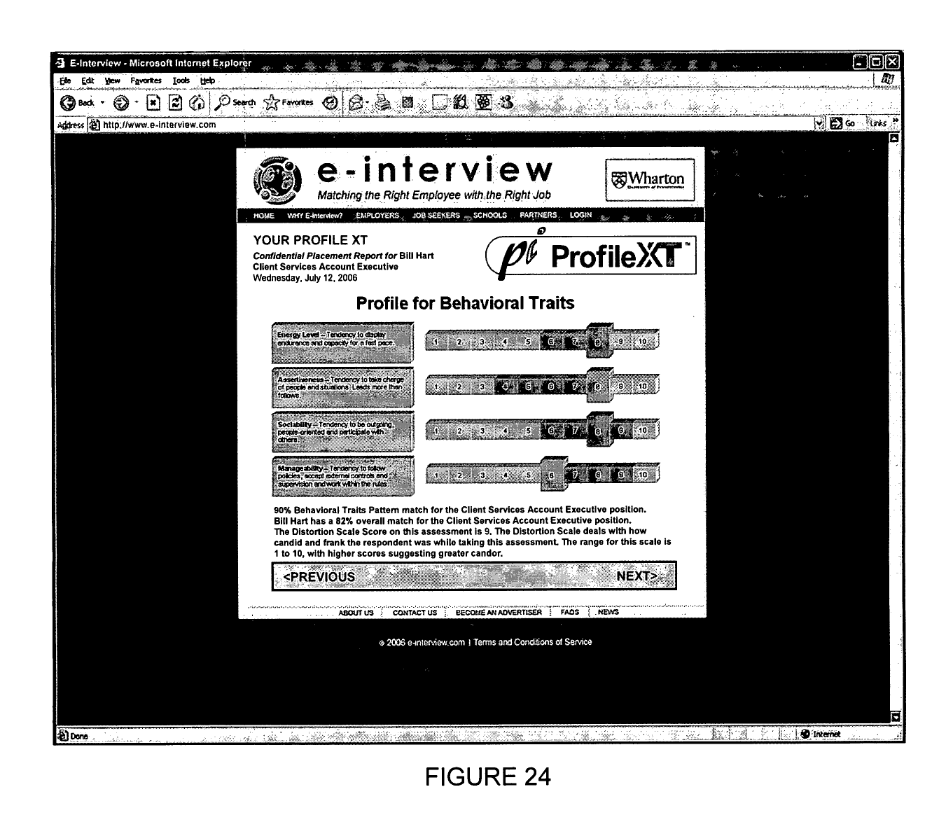

FIGS. 22 through 24 show an example of a Profile XT report for a job seeker, accessed by a employer user through the candidate master page, where that option is available.

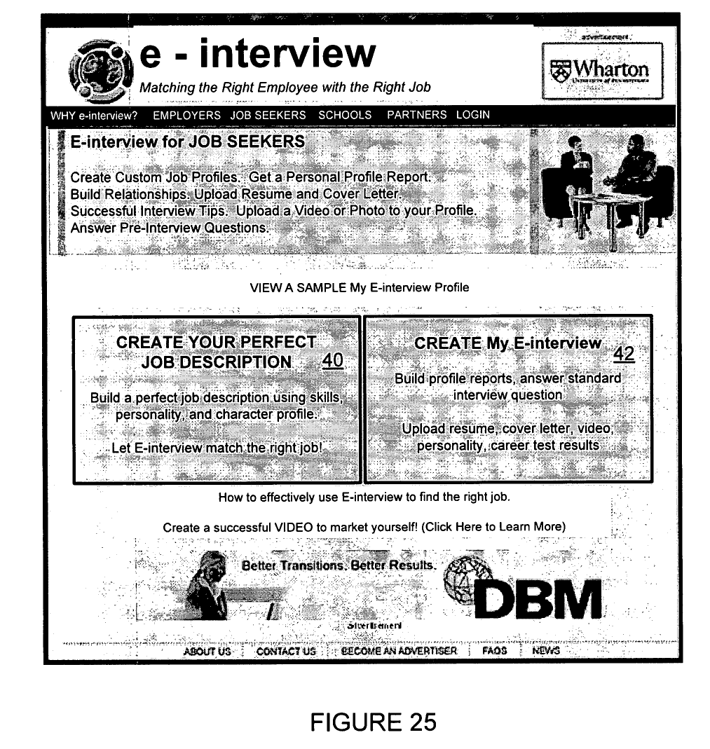

FIG. 25 shows an example of a job seeker page giving the job seeker user the option to create the “perfect” job description 40, or create the E-Interview materials 42. The user also may be able to access information about the E-Interview process, and learn how to create a successful video for use with the system. Upon selection of the perfect job description creation option, the job seeker user may be directed through the same job analysis process for employers as shown in FIGS. 12 through 16. The process shown requests the user to rank certain tasks for importance and frequency, and may be used to match the candidate to employer's job descriptions. Job seekers may also be provided statistical information about their E-Interview, such as how many times their master page and/or components have been viewed by employers, the date and times of each viewing, and the like.

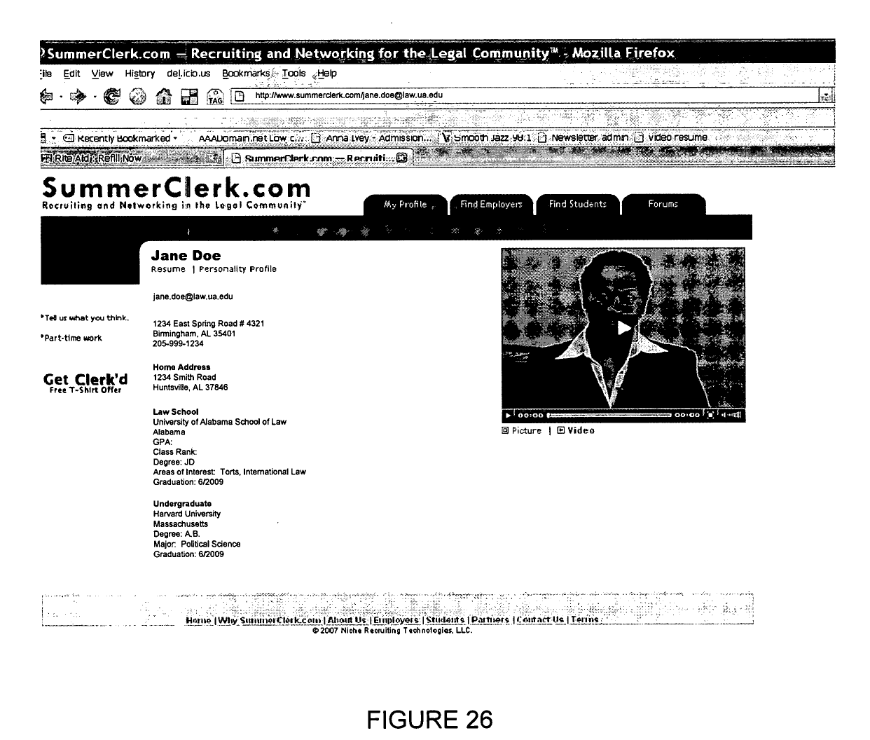

The system of the present invention may be used for general job pools of any size or area, and may also be used for particular industries, groups, and/or regions. FIG. 26 shows an example of a system used for matching law school students seeking employment as summer law clerks with law firms. This system matches the right clerks with the right law firms, thus reducing recruiting costs, expenses, and time for the law firms, while increasing productivity and the chances of a particular student finding successful employment with a firm. Other niche groups include, but are not limited to, chefs, mechanics, medical sales, and the like.

Accordingly, the system creates a three-dimensional employment process, where a candidate's technical qualifications (e.g., resume), presentation (e.g., video interview) and personality (e.g., personality profile or survey) are all presented at once, in one location, at the front end of the employment process. This reduces the time, cost and risk of the current employment process, and in particular, the risk of a poor hire.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

I claim:

1. A system for managing information for employment, comprising:
a database comprising job candidate information, said job candidate information comprising a resume, personality data, and a video presentation.

2. The system of claim 1, wherein the job candidate information may be searched by prospective employers to identify job candidates of interest, and the prospective employer can view the resume, personality data, and video presentation prior to contacting the job candidate.

3. The system of claim 1, further comprising a module for assisting the job candidate in creating their job candidate information.

4. The system of claim 2, wherein the search is based upon job description parameters determined by the prospective employer.

5. The system of claim 1, wherein the job candidate information includes a desired job description profile completed by the job candidate.

6. The system of claim 2, wherein the search is conducted by matching desired job description profile data completed by the job candidate with job description parameters determined by the prospective employer.

7. The system of claim 1, wherein an employer can profile current employees using job description profile data.

8. The system of claim 1, further comprising one or more tutorials or coaching tools to assist users in understanding, interpreting and using personality and character profile data.

9. The system of claim 1, wherein all of said job candidate information is available at a single Internet web site or page.

10. The system of claim 6, wherein the job description parameters can be maintained by the system persistently for future use by the employer.

11. The system of claim 10, wherein the employer is notified whenever new job description information for a job candidate that matches the persistent job description parameters is entered into the system.

12. The system of claim 6, wherein matching is determined as a percentage of desired job description profile data completed by the job candidate being substantially the same as corresponding job description parameters determined by the prospective employer.

13. The system of claim 1, wherein each job candidate has an individual web page or URL for providing access to elements of their job candidate data.

14. The system of claim 1, the job candidate data further comprising one or more of the following: a cover letter; a personality profile; a perfect or ideal job description exercise; a character and values profile; a values statement; a career goals statement; pre-answered job questions; employment questionnaires related to job function and values philosophy; a picture of the job candidate; and voice-only interviews.

15. A system for presenting job candidate information, comprising:
one or more web pages providing one or more links to job candidate information for job candidates, said job candidate information comprising a resume, personality data, and a video presentation,
wherein each job candidate has an individual web page or URL with links to job candidate information for that candidate.

16. A method of managing information for employment, comprising the steps of:
storing job candidate information, said job candidate information comprising a resume, personality data, and a video presentation; and
providing access to said job candidate information to one or more prospective employers, wherein said employers can search the job candidate information based upon a plurality of job description parameters.

17. The method of claim 16, wherein the job candidate information may be searched by prospective employers to identify job candidates of interest, and the prospective employer can view the resume, personality data, and video presentation prior to contacting the job candidate.

18. The system of claim 17, wherein the search is conducted by matching desired job description profile data completed by the job candidate with job description parameters determined by the prospective employer.

19. The system of claim 17, wherein the employer is notified whenever new job description information for a job candidate that matches the job description parameters is entered into the system.

20. The system of claim 18, wherein matching is determined as a percentage of desired job description profile data completed by the job candidate being substantially the same as corresponding job description parameters determined by the prospective employer.
